(19) United States
(12) Patent Application Publication
(10) Pub. No.: US 2020/0386306 A1
(43) Pub. Date: Dec. 10, 2020

(54) TRANSMISSION SHIFTER WITH TRAINED GEAR POSITION SET POINTS

(71) Applicant: GHSP, INC., Grand Haven, MI (US)

(72) Inventors: Kirk Ypma, Rockford, MI (US); Thomas Olson, Holland, MI (US)

(21) Appl. No.: 16/607,158

(22) PCT Filed: May 1, 2018
(86) PCT No.: PCT/US2018/030475

§ 371 Date: Oct. 22, 2019

Related U.S. Application Data
(60) Provisional application No. 62/492,351, filed on May 1, 2017.

(51) Int. Cl. F16H 61/12; F16H 59/68; F16H 59/10; F16H 61/28

(52) U.S. Cl. CPC F16H 61/12; F16H 59/68; F16H 59/105; F16H 2342/02; F16H 2061/1208; F16H 2061/1284; F16H 2061/283; F16H 61/2807

(57) ABSTRACT

An apparatus and method of transmission control includes a shift lever supported between gear positions P, R, N, D, and a sensor operably connected to a vehicle electrical system for generating a variable signal corresponding to the P, R, N, D gear positions. The electrical system is initially set to control shifting a transmission between P, R, N, and D gear positions based on initial P and D position-indicating signals and interpolated/proportional R and N position-indicated signals. The apparatus and method further include adjusting shifting control for improved shift location accuracy after worn shifter components have mechanically worn or electrically drifted, by determining “new” P and D gear positions when the shift lever is in component-worn P and D gear positions, respectively, and then calculating new R and N position-indicating signals.

### CROSS-REFERENCE TO RELATED APPLICATION

This application claims priority under 35 U.S.C. § 119(e) upon U.S. Provisional Patent Application No. 62/492,351, entitled “TRANSMISSION SHIFTER WITH TRAINED GEAR POSITION SET POINTS” filed on May 1, 2017, by Kirk Ypma et al., the entire disclosure of which is incorporated herein by reference.

### FIELD OF THE INVENTION

The present invention relates to transmission shifters such as are used in passenger vehicles, and more particularly relates to a shift-by-wire transmission shifter with gear position set points (i.e., “home” positions).

### BACKGROUND OF THE INVENTION

Transmission shifters for vehicles commonly use a shift lever with positions for selecting different gear positions, such as Park, Reverse, Neutral, and Drive gear positions. When electrical components are used to sense the lever position, these shifters are often called “shift by wire” transmission shifters. Currently many shift-by-wire products use a magnet and a magnetic sensor to detect a shifter lever position. Currently, the shifters are trained one time in manufacturing by placing them in Park (extreme forward) and Drive (extreme back) positions. During training, the shifters remember the outputs detected by the magnetic sensors in these two extreme positions and they establish Reverse and Neutral positions proportionally in between Park and Drive. This sets the shift positions for the life of the shifter.

A potential problem is that over time and use as the shifters suffer wear, the outputs sensed in the Park and Drive positions drift. They may change to the point that a shift from Reverse to Park may sense the Park position before the shift lever has fully exited Reverse. This could result in the shifter sending a “Park message” before the lever would stay in Park if released.

An improvement is desired that overcomes this problem, and does so in a way minimizing cost, does so in a way that does not disrupt existing assembly processes, and that provides savings/improvements in terms of cost, capital investment, efficiency of install, and safety.

### SUMMARY OF THE INVENTION

According to one aspect of the present invention, a transmission shifter apparatus is provided for a vehicle having a transmission and a vehicle electrical system that controls the transmission, the transmission shifter apparatus comprising: a shift lever movably supported for movement between at least the following gear positions: a park gear position, a reverse gear position, a neutral gear position, and a drive gear position; a sensor positioned to sense the position of the shift lever and to generate a variable output that varies proportionally in value with changes in the gear position of the shift lever; and a processor coupled to the sensor and configured to execute the following steps: (a) determine in which of the gear positions the shift lever is currently positioned based on a value of the variable output from the sensor, wherein the processor is initially trained during manufacture to associate a Park band of values of the variable output with the park gear position and a Drive band of values of the variable output with the drive gear position, wherein the Park band is centered around a trained park position, and the Drive band is centered around a trained drive position; (b) calculate both a Reverse band of values of the variable output for the reverse gear position and a Neutral band of values of the variable output for the neutral gear position based upon the Park band and the Drive band; (c) monitor the variable output of the sensor to determine whether the variable output has a value falling within one of the Park, Drive, Reverse, or Neutral bands and generating a signal indicating the gear position associated with the one of the Park, Drive, Reverse, or Neutral bands in which the value of the variable output falls; (d) determine if a condition occurs; (e) if the condition does not occur, repeat steps (c) and (d); and (f) if the condition occurs, recalibrate the Park band or the Drive band and repeat steps (c) and (d).

According to another embodiment of the present invention, a method is provided method of controlling a vehicle transmission using a processor and a shift lever movably supported for movement between gear positions park P, reverse R, neutral N, and drive D, wherein a sensor is operably connected to the processor and constructed generate a variable output that varies corresponding to the position of the shift lever. The method comprising: (a) determine in which of the gear positions the shift lever is currently positioned based on a value of the variable output from the sensor, wherein the processor is initially trained during manufacture to associate a Park band of values of the variable output with the park gear position and a Drive band of values of the variable output with the drive gear position; (b) calculate both a Reverse band of values of the variable output for the reverse gear position and a Neutral band of values of the variable output for the neutral gear position based upon the Park band and the Drive band; (c) monitor the variable output of the sensor to determine whether the variable output has a value falling within one of the Park, Drive, Reverse, or Neutral bands and generating a signal indicating the gear position associated with the one of the Park, Drive, Reverse, or Neutral bands in which the value of the variable output falls; (d) determine if a condition occurs; (e) if the condition does not occur, repeat steps (c) and (d); and (f) if the condition occurs, recalibrate the Park band or the Drive band and repeat steps (c) and (d).

According to another embodiment of the present invention, a transmission shifter apparatus is provided for a vehicle having a transmission and a vehicle electrical system that controls the transmission, the transmission shifter apparatus comprising: transmission shifter apparatus for a vehicle having a transmission and a vehicle electrical system that controls the transmission, the transmission shifter apparatus comprising: a shift lever movably supported for movement between at least the following gear positions: a park gear position, a reverse gear position, a neutral gear position, and a drive gear position; a sensor positioned to sense the position of the shift lever and to generate a variable output that varies proportionally in value with changes in the gear position of the shift lever; and a processor coupled to the sensor and configured to execute the following steps: (a) determine in which of the gear positions the shift lever is currently positioned based on a value of the variable output from the sensor, wherein the processor is initially trained during manufacture to associate a Park band of values of the variable output with the park gear position and a Drive band of values of the variable output with the drive gear position; (b) calculate both a Reverse band of values of the variable output for the reverse gear position and a Neutral band of values of the variable output for the neutral gear position based upon the Park band and the Drive band; (c) monitor the variable output of the sensor to determine whether the variable output has a value falling within one of the Park, Drive, Reverse, or Neutral bands and generating a signal indicating the gear position associated with the one of the Park, Drive, Reverse, or Neutral bands in which the value of the variable output falls; (d) determine if the variable output of the sensor has a value falling within a smaller center band of either the Park band or the Drive band; (e) if the variable output of the sensor has a value falling within the smaller center band of either the Park band or the Drive band, determine if the value remains within the smaller center band for a predetermined time period; (f) if the value of the variable output of the sensor remains within the smaller center band for the predetermined time period, determine whether the Park band or the Drive band have not been updated during a current ignition cycle; and (g) if the Park band or the Drive band have not been updated during a current ignition cycle, recalibrate the Park band or the Drive band and repeat steps (c) and (d).

These and other aspects, objects, and features of the present invention will be understood and appreciated by those skilled in the art upon studying the following specification, claims, and appended drawings.

### BRIEF DESCRIPTION OF THE DRAWINGS

The present invention will become more fully understood from the detailed description and the accompanying drawings, wherein:

FIG. 1 is a schematic side view of a transmission shifter according to an embodiment described herein with the shift lever in the drive gear position;

FIG. 2 is a schematic side view of the transmission shifter in FIG. 1 with the shift lever in the park gear position;

FIG. 3 is a flowchart illustrating the steps executed by the processor in FIG. 1; and

FIG. 4 is a flowchart illustrating a variation in the steps executed by the processor in FIG. 1.

### DETAILED DESCRIPTION OF THE EMBODIMENTS

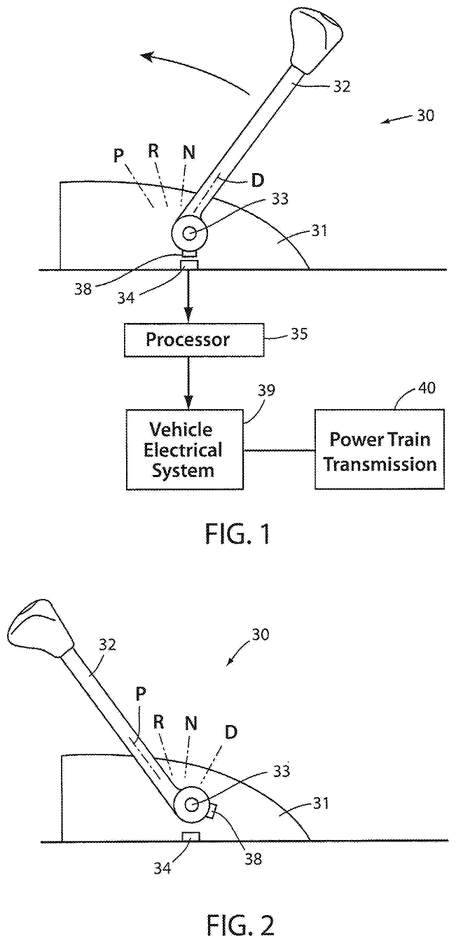

For purposes of description herein the terms “upper,” “lower,” “right,” “left,” “rear,” “front,” “vertical,” “horizontal,” and derivatives thereof shall relate to the device as oriented in FIG. 1. However, it is to be understood that the device may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise. The same or similar parts or method steps are described herein and shown in the drawings with the same reference numerals.

FIGS. 1 and 2 show a transmission shifter apparatus 30 that includes a base 31, a shift lever 32 pivoted at pivot 33, a sensor 34 that detects gear positions P, R, N, D based on movement of a magnet 38 attached and movable with the lever 32, and a processor 35 coupled to the sensor 34. The sensor 34 generates a variable output indicative of a position of the shift lever 32, and is operably connected to the processor 35, which in turn may be coupled to a vehicle electrical system 39 which controls shifting of the vehicle's transmission 40 based on a gear position provided from the processor 35, as is known in the art. The variable output of the sensor 34 is an analog output that varies proportionally to a position of the shift lever 32, and can be interpolated to determine all gear positions of the shift lever 32, even though only the Park and Drive positions are used during the initial set up/calibration. More specifically, the analog variable output of the sensor 34 is digitized by the processor 35 so that the position of the shift lever 32 is represented by a number.

The illustrated shifter apparatus 30 is provided to facilitate the present description, but it is contemplated that the present innovation is not limited to the particular shifter apparatus illustrated. In a preferred arrangement, a backup sensor may be positioned adjacent the sensor 34 for redundancy and safety.

The present shifter apparatus 30 is configured and programmed to be initially trained and calibrated during a manufacturing/assembly process of the vehicle to establish Park, Reverse, Neutral, and Drive positions, as will be understood by persons skilled in this art. Specifically, during initial calibration, when the shift lever 32 is in the park P gear position (shown in FIG. 2), the numerical digital value derived from the variable output of the sensor 34 is stored as the trained Park position and a Park band is defined with the trained Park position lying at the center of this Park band (or range) of values. Thereafter, if the numerical value of the variable output of the sensor 34 falls within this Park band, the processor 35 will determine that the shift lever is in the park gear position and will output this position to the transmission 40 either directly or via the vehicle electrical system 39. Similarly, during initial calibration, when the shift lever 32 is in the drive D gear position (shown in FIG. 1), the numerical digital value derived from the variable output of the sensor 34 is stored as the trained Drive position and a Drive band is defined with the trained Drive position lying at the center of this Drive band (or range) of values. Thereafter, if the numerical value of the variable output of the sensor 34 falls within this Drive band, the processor 35 will determine that the shift lever is in the drive gear position and will output this position to the transmission 40 either directly or via the vehicle electrical system 39. The processor 35 may use the Park and Drive bands to then interpolate a separate Neutral band and a Reverse band that are used to determine when the shift lever 32 is in either the neutral gear position or the reverse gear position, respectively. There may or may not be a dead zone in between bands depending on the manufacturer's specifications.

The present shifter apparatus 30 is also configured and programmed to recalibrate in order to overcome the issue of problematic wear and drift in components over time leading to potential premature or delayed generation of control signals. Specifically, the present innovation allows the trained Park and Drive bands to be updated under certain conditions when the shifter is in either of those positions. These conditions that allow trained Park and Drive band updates are: 1) only allow updates when the shift lever 32 is in a smaller band in the center of the Park or Drive bands; 2) only allow updates when the shifter has been in the small center band for a minimum length of time such as 1 minute; and/or 3) only allow one update in each trained position (Park and Drive) per ignition cycle. In a preferred embodiment, the update is an average of the trained and currently sensed gear positions heavily weighted in favor of the trained gear position. For example, the Park position could be updated using the following formula:

New Trained Park=(⅞×Old Trained Park)+(⅛×Current Sensed Park)

This formula causes the trained Park position to move ⅛ of the numerically represented distance from the old trained Park position in the direction of the currently sensed Park position.

Each of the constants given in the conditions and in the formula are only examples. The actual constants used must be selected by engineering analysis and testing. The cost of the present innovation is the upfront software engineering and a small amount of code to implement on each shifter. This saves the need for much higher cost higher precision magnets and saves the need for higher-cost mechanical parts intended to increase durability. Notably, mechanical components often sound more “clicky” and make it difficult to achieve the “feel” that most customers want.

The primary sensor 34 (and an optional duplicate sensor (not shown)) senses a position of the shift lever 32, and as illustrated, is located directly under the pivot point 33. However, it is contemplated that other positions and arrangements will be clear to those skilled in this art. The variable output generated by the sensor 34 is proportional to a distance of the sensor 34 from the magnet 38.

The processor 35 may be a part of the vehicle electrical system 39 or it may be a separate processor that is disposed in or near the base 31.

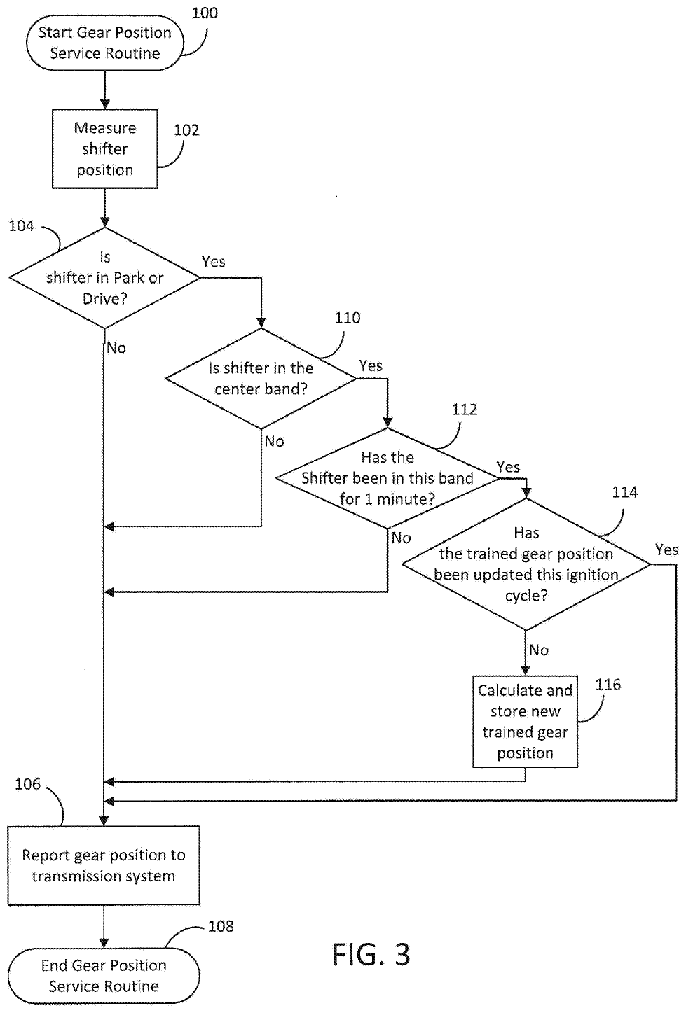

FIG. 3 is a flowchart illustrating an example of the steps of a gear position service routine 100 that may be executed by the processor 35. The first step 102 is to measure the position of the shift lever 32 using the variable output of the sensor 34. Then in step 104, the processor 35 determines if the measured shift lever position indicates that the shift lever 32 is in the park P or drive D gear position. This is done by determining if the numerical value representing the variable output falls within the Park band or Drive band of values to which the shifter apparatus has been last calibrated for either the park P or drive D gear position. If the processor 35 determines that the shift lever 32 is not in the park P or drive D gear positions, the processor 35 reports the gear position (i.e., neutral or reverse) to the transmission 40 either directly or via the vehicle electrical system 39 in step 106. The processor 35 would then end the routine 100 in step 108. The routine 100 may be run at periodic intervals or upon sensing an event.

If, in step 104, the processor 35 determines that the shift lever 32 is in the park P or drive D gear position, the processor 35 then determines if the shift lever 32 is in a position corresponding to the center of the Park band or Drive band in step 110. More specifically, the processor 35 determines if the numerical value representing the variable output is centered within the band of values to which the shifter apparatus has been last calibrated for the corresponding park P or drive D gear position. If the shift lever 32 is not in a position corresponding to the center of the Park band or Drive band, the processor 35 reports the gear position to the transmission 40 in step 106. The processor 35 would then end the routine 100 in step 108.

If, in step 110, the processor 35 determines that the shift lever 32 is in a position corresponding to the center of the Park band or Drive band, the processor 35 then determines whether the shift lever 32 has remained in this band for a predetermined time period (for example, 1 minute) in step 112. If the shift lever 32 does not remain in this band for the predetermined time period, the processor 35 reports the gear position to the transmission 40 in step 106. The processor 35 would then end the routine 100 in step 108.

If in step 112, the processor 35 determines that the shift lever 32 has remained in this band for the predetermined time period, the processor 35 then determines if the trained gear position has been updated in the current ignition cycle in step 114. If it has been updated in this ignition cycle, the processor 35 reports the gear position to the transmission 40 in step 106. The processor 35 would then end the routine 100 in step 108.

If in step 114, the processor 35 determines that the trained gear position has not been updated in the current ignition cycle, the processor 35 then executes step 116 in which the processor 35 calculates and stores a new trained gear position. The new trained gear position can be an average of the previously trained and currently sensed gear positions heavily weighted in favor of the previously trained gear position. For example, as mentioned above, the Park position could be updated using the following formula:

New Trained Park=(⅞×Old Trained Park)+(⅛×Current Sensed Park)

The Park or Drive band may then be updated based on the new trained park/drive position and the Reverse and Neutral bands may then be recomputed based on the updated Park/Drive band. After step 116, the processor 35 reports the gear position to the transmission 40 in step 106. The processor 35 would then end the routine 100 in step 108.

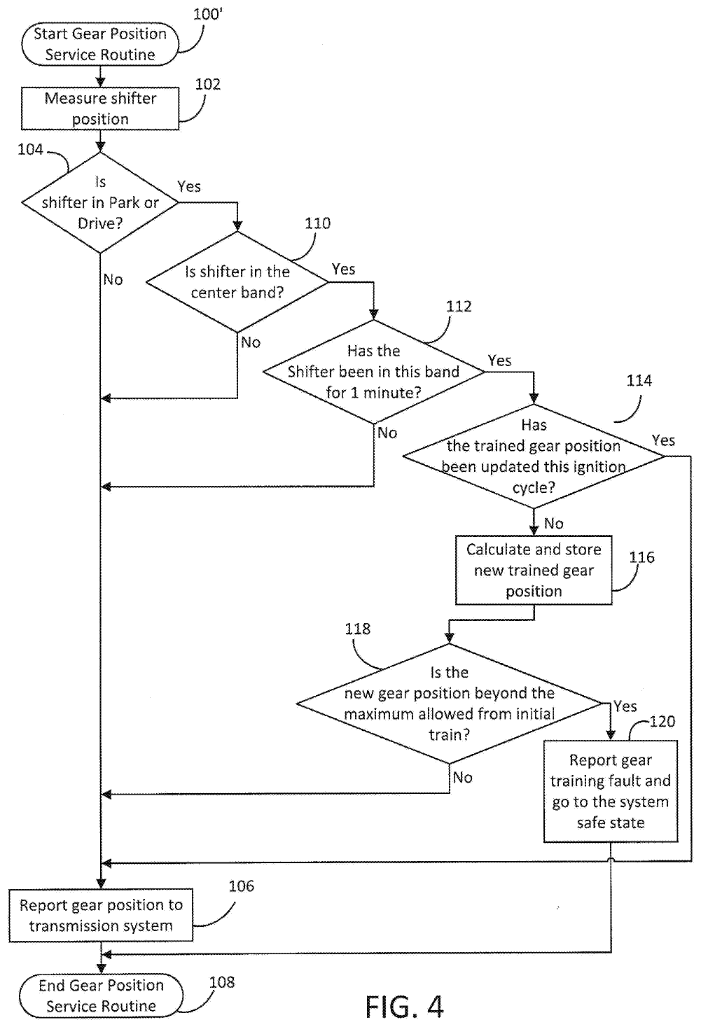

A slight variation to the routine 100 described above and shown in FIG. 3 is described below and shown in FIG. 4 as a routine 100′. The common steps of routines 100 and 100′ are shown with the same reference numerals. The difference between the routine 100 and routine 100′ is that the routine 100′ of FIG. 4 includes additional steps 118 and 120. More specifically, after calculating and storing a new trained gear position in step 116, the processor 35 determines in step 118 if the new gear position is beyond the maximum allowed from the initial calibration training. If it is not beyond the maximum allowed, the processor 35 reports the gear position to the transmission 40 in step 106. The processor 35 would then end the routine 100 in step 108.

However if, in step 118, the processor 35 determines that the new gear position is beyond the maximum allowed from the initial calibration training, the processor 35 reports a gear training fault to the vehicle electrical system 39 and goes into a “safe” state in step 120 whereby the gear position is not changed. The processor 35 would then end the routine 100 in step 108 without first reporting the gear position to the transmission 40.

It will be understood by one having ordinary skill in the art that construction of the described device and other components is not limited to any specific material. Other exemplary embodiments of the device disclosed herein may be formed from a wide variety of materials, unless described otherwise herein.

Although the above methods are described as being performed by processor 35, all or portions of the methods may be performed by any other controller, microprocessor, microcontroller, logic circuit, or programmed gate array, either separately or in combination.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the device as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present device. The exemplary structures and processes disclosed herein are for illustrative purposes and are not to be construed as limiting.

It is also to be understood that variations and modifications can be made on the aforementioned structures and methods without departing from the concepts of the present device, and further it is to be understood that such concepts are intended to be covered by the following claims unless these claims by their language expressly state otherwise.

The above description is considered that of the preferred embodiments only.

Modifications of the invention will occur to those skilled in the art and to those who make or use the invention. Therefore, it is understood that the embodiments shown in the drawings and described above are merely for illustrative purposes and not intended to limit the scope of the invention, which is defined by the claims as interpreted according to the principles of patent law, including the doctrine of equivalents.

1. A transmission shifter apparatus for a vehicle having a transmission and a vehicle electrical system that controls the transmission, the transmission shifter apparatus comprising:
a shift lever movably supported for movement between at least the following gear positions: a park gear position, a reverse gear position, a neutral gear position, and a drive gear position;
a sensor positioned to sense the position of the shift lever and to generate a variable output that varies proportionally in value with changes in the gear position of the shift lever; and
a processor coupled to the sensor and configured to execute the following steps:
(a) determine in which of the gear positions the shift lever is currently positioned based on a value of the variable output from the sensor, wherein the processor is initially trained during manufacture to associate a Park band of values of the variable output with the park gear position and a Drive band of values of the variable output with the drive gear position, wherein the Park band is centered around a trained park position, and the Drive band is centered around a trained drive position;
(b) calculate both a Reverse band of values of the variable output for the reverse gear position and a Neutral band of values of the variable output for the neutral gear position based upon the Park band and the Drive band;
(c) monitor the variable output of the sensor to determine whether the variable output has a value falling within one of the Park, Drive, Reverse, or Neutral bands and generating a signal indicating the gear position associated with the one of the Park, Drive, Reverse, or Neutral bands in which the value of the variable output falls;
(d) determine if a condition occurs;
(e) if the condition does not occur, repeat steps (c) and (d); and
(f) if the condition occurs, recalibrate the Park band or the Drive band and repeat steps (c) and (d).

2. The transmission shifter apparatus of claim 1, wherein the condition includes at least one of: the variable output of the sensor has a value falling within a smaller center band of either the Park band or the Drive band; and the Park band or the Drive band have not been updated during a current ignition cycle.

3. The transmission shifter apparatus of claim 1, wherein the condition includes:
the variable output of the sensor has a value falling within a smaller center band of either the Park band or the Drive band; and the variable output of the sensor has a value remaining within the smaller center band of either the Park band or the Drive band for a predetermined time period.

4. The transmission shifter apparatus of claim 1, wherein the condition includes: the variable output of the sensor has a value falling within a smaller center band of either the Park band or the Drive band; the variable output of the sensor has a value remaining within the smaller center band of either the Park band or the Drive band for a predetermined time period; and the Park band or the Drive band have not been updated during a current ignition cycle.

5. The transmission shifter apparatus of claim 1, wherein, in step (f), the Park band or the Drive band is recalculated by computing a new trained park or drive gear position using a weighted average of the previously trained park or drive gear position and a currently sensed gear position.

6. The transmission shifter apparatus of claim 5, wherein the weighted average is equal to ⅛×currently sensed gear position+⅞×the previously trained gear position.

7. The transmission shifter apparatus of claim 1, wherein after step (f), the processor is further configured to (g) determine whether a new gear position is beyond a maximum allowed from initial calibration training, and (h) if the new gear position is beyond the maximum, report a gear training fault while entering into a safe state whereby the gear position is not changed.

8. The transmission shifter apparatus of claim 1, further comprising a magnet secured to the shift lever, wherein the sensor is a magnetic sensor for sensing proximity of the magnet.

9. A method of controlling a vehicle transmission using a processor and a shift lever movably supported for movement between gear positions park P, reverse R, neutral N, and drive D, wherein a sensor is operably connected to the processor and constructed to generate a variable output that varies corresponding to the position of the shift lever, the method comprising:
(a) determine in which of the gear positions the shift lever is currently positioned based on a value of the variable output from the sensor, wherein the processor is initially trained during manufacture to associate a Park band of values of the variable output with the park gear position and a Drive band of values of the variable output with the drive gear position;
(b) calculate both a Reverse band of values of the variable output for the reverse gear position and a Neutral band of values of the variable output for the neutral gear position based upon the Park band and the Drive band;
(c) monitor the variable output of the sensor to determine whether the variable output has a value falling within one of the Park, Drive, Reverse, or Neutral bands and generating a signal indicating the gear position associated with the one of the Park, Drive, Reverse, or Neutral bands in which the value of the variable output falls;
(d) determine if a condition occurs;
(e) if the condition does not occur, repeat steps (c) and (d); and
(f) if the condition occurs, recalibrate the Park band or the Drive band and repeat steps (c) and (d).

10. The method of claim 9, wherein the condition includes at least one of: the variable output of the sensor has a value falling within a smaller center band of either the Park band or the Drive band; and the Park band or the Drive band have not been updated during a current ignition cycle.

11. The method of claim 9, wherein the condition includes: the variable output of the sensor has a value falling within a smaller center band of either the Park band or the Drive band; and the variable output of the sensor has a value remaining within the smaller center band of either the Park band or the Drive band for a predetermined time period.

12. The method of claim 9, wherein the condition includes: the variable output of the sensor has a value falling within a smaller center band of either the Park band or the Drive band; the variable output of the sensor has a value remaining within the smaller center band of either the Park band or the Drive band for a predetermined time period; and the Park band or the Drive band have not been updated during a current ignition cycle.

13. The method of claim 9, wherein, in step (f), the Park band or the Drive band is recalculated by computing a new trained park or drive gear position using a weighted average of the previously trained park or drive gear position and a currently sensed gear position.

14. The method of claim 13, wherein the weighted average is equal to ⅛×currently sensed gear position+⅞×the previously trained gear position.

15. The method of claim 9, wherein after step (f), perform the following steps: (g) determine whether a new gear position is beyond a maximum allowed from initial calibration training, and (h) if the new gear position is beyond the maximum, report a gear training fault while entering into a safe state whereby the gear position is not changed.

16. A transmission shifter apparatus for a vehicle having a transmission and a vehicle electrical system that controls the transmission, the transmission shifter apparatus comprising:
a shift lever movably supported for movement between at least the following gear positions: a park gear position, a reverse gear position, a neutral gear position, and a drive gear position;
a sensor positioned to sense the position of the shift lever and to generate a variable output that varies proportionally in value with changes in the gear position of the shift lever; and
a processor coupled to the sensor and configured to execute the following steps:
(a) determine in which of the gear positions the shift lever is currently positioned based on a value of the variable output from the sensor, wherein the processor is initially trained during manufacture to associate a Park band of values of the variable output with the park gear position and a Drive band of values of the variable output with the drive gear position;
(b) calculate both a Reverse band of values of the variable output for the reverse gear position and a Neutral band of values of the variable output for the neutral gear position based upon the Park band and the Drive band;
(c) monitor the variable output of the sensor to determine whether the variable output has a value falling within one of the Park, Drive, Reverse, or Neutral bands and generating a signal indicating the gear position associated with the one of the Park, Drive, Reverse, or Neutral bands in which the value of the variable output falls;
(d) determine if the variable output of the sensor has a value falling within a smaller center band of either the Park band or the Drive band;
(e) if the variable output of the sensor has a value falling within the smaller center band of either the Park band or the Drive band, determine if the value remains within the smaller center band for a predetermined time period;
(f) if the value of the variable output of the sensor remains within the smaller center band for the predetermined time period, determine whether the Park band or the Drive band have not been updated during a current ignition cycle; and
(g) if the Park band or the Drive band have not been updated during a current ignition cycle, recalibrate the Park band or the Drive band and repeat steps (c) and (d).

17. The transmission shifter apparatus of claim 16, wherein, in step (g), the Park band or the Drive band is recalculated by computing a new trained park or drive gear position using a weighted average of the previously trained park or drive gear position and a currently sensed gear position.

18. The transmission shifter apparatus of claim 17, wherein the weighted average is equal to ⅛×currently sensed gear position+⅞×the previously trained gear position.

19. The transmission shifter apparatus of claim 16, wherein after step (g), the processor is further configured to (h) determine whether a new gear position is beyond a maximum allowed from initial calibration training, and (i) if the new gear position is beyond the maximum, report a gear training fault while entering into a safe state whereby the gear position is not changed.

20. The transmission shifter apparatus of claim 16, further comprising a magnet secured to the shift lever, wherein the sensor is a magnetic sensor for sensing proximity of the magnet.
